(19) United States
(12) Patent Application Publication
(10) Pub. No.: US 2023/0029517 A1
(43) Pub. Date: Feb. 2, 2023

(54) COMPUTING DEVICES WITH BATTERY RESERVE MODES

(71) Applicant: Hewlett-Packard Development Company, L.P., Spring, TX (US)

(72) Inventors: Isaac Lagnado, Spring, TX (US); Christopher Charles Mohrman, Spring, TX (US); Charles J. Stancil, Spring, TX (US); Steven Petit, Spring, TX (US); Jonathan Vu, Spring, TX (US); Monji G. Jabori, Spring, TX (US)

(73) Assignee: Hewlett-Packard Development Company, L.P., Spring, TX (US)

(21) Appl. No.: 17/789,626

(22) PCT Filed: Jan. 22, 2020
(86) PCT No.: PCT/US2020/014533

§ 371 Date: Jun. 28, 2022

(51) Int. Cl. H02J 7/00; G06F 1/3212; G16Y 30/00

(52) U.S. Cl. CPC H02J 7/0068; H02J 7/0063; H02J 7/0048; H02J 7/00712; G06F 1/3212; G16Y 30/00

(57) ABSTRACT

In some examples, a computing device can include a component device, a battery, and a memory resource storing instructions to cause a processing resource to determine an operating mode of the computing device, in response to the operating mode being a charging mode, cause the battery to charge, in response to the operating mode being a system battery mode, cause the battery to power the computing device, and in response to the operating mode being a battery reserve mode, cause the battery to power the component device in absence of powering other components of the computing device.

### BACKGROUND

Computing devices can utilize a battery in order to function when not connected to a power source. The battery can provide power to a computing device when the computing device is not connected to a power source. When the computing device is connected to a power source, the power source can charge the battery so that the battery can provide power to the computing device when the computing device is subsequently disconnected from the power source.

### BRIEF DESCRIPTION OF THE DRAWINGS

FIG. 1 is an example of a computing device having battery reserve modes consistent with the disclosure.

FIG. 2 illustrates an example of a computing device having battery reserve modes consistent with the disclosure.

FIG. 3 illustrates a block diagram of an example system consistent with the disclosure.

FIG. 4 illustrates an example of a method for computing devices with battery reserve modes consistent with the disclosure.

### DETAILED DESCRIPTION

A computing device can utilize a battery to power the computing device when the computing device is not connected to a power source. The battery can be recharged when the computing device is connected to a power source. As used herein, the term “battery” refers to a device to store an electric charge.

As used herein, the term “computing device” refers to an electronic system having a processing resource, memory resource, and/or an application-specific integrated circuit (ASIC). Examples of computing devices can include, for instance, a laptop computer, a notebook computer, a desktop computer, networking device (e.g., router, switch, etc.), and/or a mobile device (e.g., a smart phone, tablet, personal digital assistant, smart glasses, a wrist-worn device, etc.), among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

Certain computing devices may include component devices. Such component devices can provide various functionality to the computing device. In order to provide these various functions, component devices have to be powered. In some examples, a component device of the computing device can be powered utilizing power from a power source connected to the computing device. In some examples, a component device of the computing device can be powered via the battery of the computing device when the computing device is not connected to a power source.

Accordingly, the component devices can be powered to provide functionality to the computing device. However, in an instance in which the computing device is not connected to a power source and a charge capacity of the battery is depleted, such component devices cease to provide functionality to the computing device. For example, when a charge capacity of the battery is depleted, no power is available to be provided to a component device, rendering the component device inoperable.

However, operation of certain component devices may be beneficial, even if the rest of the computing device, including other component devices, is not powered. For example, certain component devices may be utilized to provide manageability features, security features, etc.

Computing devices with battery reserve modes, according to the disclosure, can allow for a battery of a computing device to power a component device of the computing device in absence of powering the other components of the computing device. Such a component device can be powered via a reserve amount of power from a battery of the computing device to allow the component device to function in the absence of other components of the computing device by utilizing the reserved amount of power from the battery. Powering the component device can allow for manageability features, security features, etc., to be available even if the rest of the computing device is powered off.

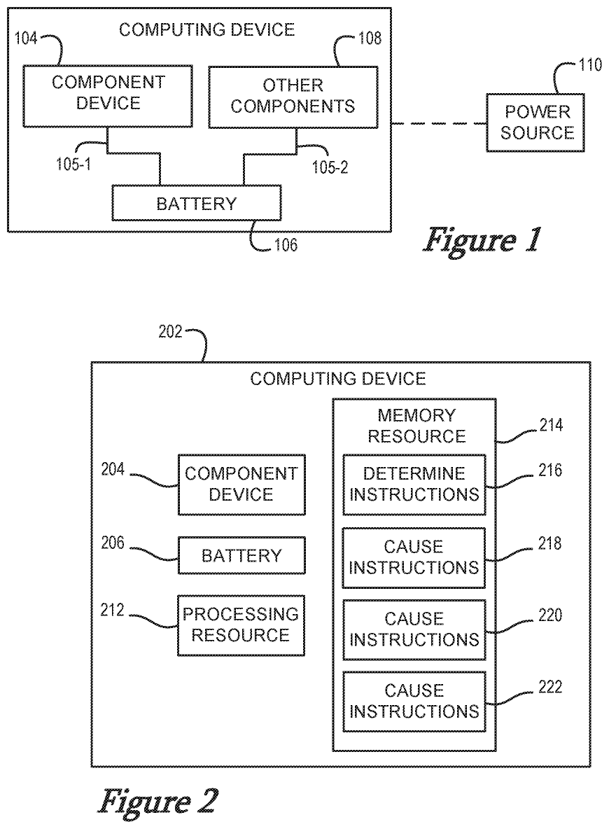

FIG. 1 is an example of a computing device 102 having battery reserve modes consistent with the disclosure. The computing device 102 can include a component device 104, power rails 105-1, 105-2, a battery 106, other components 108, and a power source 110.

The computing device 102 can reserve a predetermined amount of charge capacity in the battery 106. The predetermined amount of charge capacity in the battery 106 can be utilized by the component device 104 in an instance when a charge capacity of the battery 106 is less than a threshold charge capacity, as is further described herein. Providing the component device 104 with power from the reserved amount of charge capacity in the battery 106 can allow the component device 104 to function in absence of the other components 108 of the computing device 102, as is further described herein.

As illustrated in FIG. 1, the computing device 102 can include the component device 104. As used herein, the term “component device” refers to an electrical apparatus that is part of a greater system. For example, the component device 104 can be a device that is utilized by the computing device 102 to perform a task.

In some examples, the component device 104 can be a sensor. As used herein, the term “sensor” refers to a device to detect an event or change in its environment and, in response, transmit information. For example, the component device 104 can be a sensor to detect changes in and/or around the environment of computing device 102 and can transmit information related to the change to a processing resource of the computing device 102. Examples of sensors can include, for instance, motion sensors, temperature sensors, sound sensors, moisture/humidity sensors, pressure sensors, gas sensors, light sensors, among other types of sensors.

In some examples, the component device 104 can be a communication device. As used herein, the term “communication device” refers to a device to transmit information (e.g., a signal) from one location to another location. For example, the component device 104 can be a communication device to transmit a signal to a processing resource of the computing device 102, to another computing device either directly or via a network device (e.g., not illustrated in FIG. 1), etc. Examples of communication devices can include, for instance, Bluetooth devices, Infrared devices, modems, network cards (e.g., such as Ethernet and/or others), Wi-Fi devices, among other types of communication devices.

In some examples, the component device 104 can be an Internet-of-Things (IoT) device. As used herein, the term “IoT device” refers to a device having the ability to connect to the Internet and is included in a system of interrelated devices having unique identifiers such that the device can transfer data over a network to other devices included in the system of interrelated devices. For example, the component device 104 can be an IoT device to transmit information to other devices over a network. Examples of IoT devices can include, for instance, a beacon location device, Bluetooth device, Wi-Fi device, global positioning system (GPS) device, among other types of IoT devices.

The network as described above can be any type of network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WMAX), infrared (IR) communication, Public Switched Telephone Network (PSTN), radio waves, and/or the Internet, among other types of network relationships.

Although the component device 104 is described above as being a sensor, a communication device, and/or an IoT device, examples of the disclosure are not so limited. For example, the component device 104 can be any other type of device.

As illustrated in FIG. 1, the computing device 102 can include the other components 108. The other components 108 can be, for example, any components of the computing device 102 other than the component device 104, the power rails 105-1, 105-2, and the battery 106. For example, the other components 108 can include a motherboard, power supply, drives (e.g., floppy, optical (CD-ROM, CD-RW, DVD-ROM, etc.)), hard disk, video card, sound card, peripheral devices (e.g., keyboard, touchpad, mouse, etc.), among other components.

The computing device 102 can include the battery 106. As described above, the battery 106 can be a device to provide power to electrical devices. The battery 106 can include a charge capacity. As used herein, the term “charge capacity” refers to an amount of charge stored by the battery. That is, the charge capacity can represent the maximum amount of energy that can be extracted from the battery 106 under specified conditions.

The battery 106 can power the computing device 102 utilizing the energy stored in the battery 106. However, under certain circumstances, the battery 106 may power the component device 104 in absence of the other components 108 based on the charge capacity relative to a threshold charge capacity. As described herein, the term “threshold charge capacity” refers to a capacity that serves as a benchmark for comparison to cause an action. For instance, a charge capacity above or below the threshold charge capacity can determine an operating mode of the computing device 102, where the operating mode of the computing device 102 can determine which components 104, 108 of the computing device 102 are powered. For example, in an instance in which the charge capacity of the battery 106 is greater than a threshold charge capacity, the computing device 102 can be in a system battery mode and in an instance in which the charge capacity of the battery 106 is less than a threshold charge capacity, the computing device 102 can be in a battery reserve mode, as is further described herein.

The computing device 102 can determine an operating mode. As used herein, the term “operating mode” refers to a set of conditions that dictate a manner in which a task is performed. For example, the operating mode can include a set of conditions to which power is provided by the battery 106 to the components 104, 108 of the computing device 102. Operating modes of the computing device 102 can include a charging mode, a system battery mode, and/or a battery reserve mode, as are further described herein.

As illustrated in FIG. 1, in some examples, the computing device 102 can be connected to a power source 110. As used herein, the term “power source” refers to a location from which electrical power can be provided. For instance, in some examples, the computing device 102 can be connected to the power source 110. In such an example, the computing device 102 can determine the operating mode of the computing device 102 to be in a charging mode. As used herein, the term “charging mode” refers to a condition in which electrical power is supplied to the battery 106 of the computing device 102 and/or to the component device 104 and the other components 108 of the computing device 102 by the power source 110 such that the computing device 102 (e.g., including the component device 104 and the other components 108) may be powered on and function. For example, a user may have connected the computing device 102 to the power source 110, and the computing device 102 can determine it is in the charging mode. In response to the operating mode being in charging mode, the computing device 102 can cause the battery 106 to charge.

In some examples, the computing device 102 may not be connected to the power source 110. In such an example, the computing device 102 can determine the operating mode of the computing device 102 to be in a system battery mode or in a battery reserve mode, as is further described herein.

The computing device 102 can determine it is in a system battery mode in response to the battery 106 having a charge capacity that is greater than a threshold charge capacity and the computing device 102 not being connected to the power source 110. As used herein, the term “system battery mode” refers to a condition in which electrical power is supplied to the component device 104 and the other components 108 of the computing device 102 by the battery 106 such that the computing device 102 (e.g., including the component device 104 and the other components 108) may be powered on and function. For example, a user may not have connected the computing device 102 to the power source 110 and/or be utilizing the computing device 102 in a location remote from the power source 110. In such an example, in response to the charge capacity of the battery being greater than the threshold charge capacity, the computing device 102 can determine it is in the system battery mode and the battery 106 can power the component device 104 and the other components 108, allowing the computing device 102 to function.

For example, the threshold charge capacity can be 2% of the charge capacity of the battery 106. The user may be utilizing the computing device 102 and the battery charge capacity of the battery 106 can be 45%. Accordingly, the computing device 102 can determine that the battery charge capacity (e.g., 45%) of the battery 106 is greater than the threshold charge capacity (e.g., 2%), and determine it is in the system battery mode and cause the battery 106 to power the computing device 102.

As illustrated in FIG. 1, the component device 104 can be connected to the battery 106 by a dedicated power rail 105-1. As used herein, the term “power rail” refers to a conductive material connecting one electrical component to another electrical component. For example, the battery 106 can power the component device 104 via the dedicated power rail 105-1 by transmitting electrical energy over the dedicated power rail 105-1 from the battery 106 to the component device 104. Further, the battery 106 can power the other components 108 via power rail 105-2.

Although not illustrated in FIG. 1, in some examples the battery 106 can power the component device 104 and the other components 108 via a shared power rail. For example, the battery 106 can power the component device 104 and the other components 108 by transmitting electrical energy over the shared power rail from the battery 106 to the component device 104 and to the other components 108 via the shared power rail.

In an example in which the component device 104 and the other components 108 are on a shared power rail, the computing device 102 can provide instructions to the component device 104 and/or the other components 108 while the computing device 102 is powered off. For instance, when a shared power architecture is used, the computing device 102 can inform each component as to when it should go into a powered or powered off mode via a particular data protocol. The computing device 102 can include information including how long the component should be powered after receiving the information. By providing the instructions to the component device 104 and/or the other components 108, the computing device 102 can direct operation of the component device 104 and/or the other components 108 even when the computing device 102 is powered off. For example, the component device 104 and a real-time clock (RTC) can share a power rail. The computing device 102 can transmit instructions to the RTC clock to continue to draw power from the battery 106 until the battery 106 discharges, and transmit instructions to the component device 104 to draw power from the battery 106 for a predetermined amount of time (e.g., 30 days) in response to the battery 106 having the charge capacity that is less than the threshold charge capacity (e.g., as is further described herein). Accordingly, in an example in which the component device 104 and the other components 108 are on a shared power rail, the computing device 102 can provide instructions such that the component device 104 and/or the other components 108 know how to operate once the computing device 102 (e.g., a power management controller) is in a battery reserve mode.

The computing device 102 can determine it is in a battery reserve mode in response to the battery 106 having a charge capacity that is less than a threshold charge capacity and the computing device 102 not being connected to the power source 110. As used herein, the term “battery reserve mode” refers to a condition in which electrical power is supplied to the component device 104 by the battery 106 such that the component device 104 may be powered on and function. For example, the charge capacity of the battery 106 may be depleted to a point where it is less than the threshold charge capacity. In such an example, the computing device 102 can determine it is in the battery reserve mode and power the component device 104 in absence of powering the other components 108. The battery 106 can power the component device 104 via the dedicated power rail 105-1.

For example, the threshold charge capacity can be 2% of the charge capacity of the battery 106 and the battery charge capacity of the battery 106 is 1.9%. In response, the computing device 102 can power off the other components 108, and the battery 106 can provide power to the component device 104. For example, the component device 104 can be an IoT device. Even though the computing device 102, including the other components 108, may not be powered (e.g., in response to the computing device 102 being in the battery reserve mode), the battery 106 may provide power to the IoT device to allow the IoT device to provide manageability and/or security features, among other functionalities.

The computing device 102 can prevent the other components 108 from being powered by the battery 106 in response to the battery 106 having the charge capacity that is less than the threshold charge capacity (e.g., and accordingly, the computing device 102 being in the battery reserve mode). Preventing the other components 108 from being powered by the battery 106 can help to preserve the power in the battery 106 reserved to power the component device 104 to allow the component device 104 to be powered for various periods of time.

In some examples, the threshold charge capacity can be modifiable. For example, a user may desire the threshold charge capacity to be modified to include additional charge capacity such that the component device 104 may be powered for a longer period of time in the battery reserve mode. Accordingly, in response to a user input, the threshold charge capacity may be modified (e.g., from 2%) to 3% or any other charge capacity amount. However, examples of the disclosure are not so limited. For instance, the user may desire the threshold charge capacity to be modified to include less charge capacity such that the other components 108 are able to utilize more of the charge capacity of the battery 106 (e.g., and the component device 104 may be powered for a shorter period of time in the battery reserve mode). Accordingly, in response to a user input, the threshold charge capacity may be modified (e.g., from 2%) to 1% or any other charge capacity amount.

In some examples, the threshold charge capacity can be removable. For example, a user may desire the threshold charge capacity to be completely removed. A threshold charge capacity may be removed in an instance in which there is no desire for the component device 104 to be powered in a battery reserve mode, the component device 104 is removed from the computing device 102, there is no desire to include a battery reserve mode, etc. Accordingly, in response to a user input, the threshold charge capacity may be removed (e.g., by changing the threshold charge capacity from 2% to 0%).

In some examples, the component device 104 can transmit a request to cause the battery to power a component included in the other components 108 in the battery reserve mode (e.g., the charge capacity of the battery 106 being less than the threshold charge capacity). For instance, the component device 104 can be an IoT device. The IoT device can transmit a request to cause another component (e.g., a sound card) to be temporarily powered by the battery 106 during the battery reserve mode. In such an example, the sound card may be temporarily powered to cause an audio device such as a speaker to generate an alert.

The computing device 102 can detect an additional component device being connected to the computing device 102. For example, as illustrated in FIG. 1, the computing device 102 can include a component device 104, where the component device 104 is an IoT device. In some examples, a user may connect an additional IoT device to the computing device 102. In response to the battery 106 having the charge capacity that is less than the threshold charge capacity (e.g., such that the computing device 102 is operating in the battery reserve mode), the computing device 102 can cause the battery 106 to power the component device 104 (e.g., the IoT device) as well as the additional IoT device in absence of powering the other components 108 of the computing device 102. Accordingly, additional component devices may be added to the computing device 102 and such component devices may also be powered by the battery 106 when the computing device 102 is operating in the battery reserve mode. Additionally, the threshold charge capacity may be modified (e.g., increased or decreased) automatically or in response to a user input to accommodate the additional component device connected to the computing device 102.

Although not illustrated in FIG. 1, in some examples, the computing device 102 may not include a component device 104. For example, the computing device 102 may be shipped to a customer without a component device 104, but the customer may desire to add a component device 104. Accordingly, the computing device 102 can detect the addition of the component device 104 in response to the component device 104 being connected to the computing device 102 and in response, cause the battery 106 to power the component device 104 in absence of powering the other components 108 of the computing device 102 in response to the battery 106 having a charge capacity that is less than the threshold charge capacity (e.g., when the computing device 102 is operating in the battery reserve mode).

Computing devices with battery reserve modes, according to the disclosure, can allow for a portion of a charge capacity of a battery to be reserved in order to power a component device of a computing device in absence of powering other components of the computing device when the charge capacity of the battery is less than a threshold charge capacity. The component device can accordingly continue to function even though the other components of the computing device are powered off, allowing for manageability features, security features, etc. to be available even if the computing device is powered off.

FIG. 2 illustrates an example of a computing device 202 having battery reserve modes consistent with the disclosure. As described herein, the computing device 202 may perform functions related to computing devices with battery reserve modes. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and across multiple processors. Put another way, the instructions executed by the computing device 202 may be stored across multiple machine-readable storage mediums and executed across multiple processors, such as in a distributed or virtual computing environment. The computing device 202 may further include a component device 204 and a battery 206.

Processing resource 212 may be a central processing unit (CPU), a semiconductor-based microprocessor, and/or other hardware devices suitable for retrieval and execution of machine-readable instructions 216, 218, 220, 222 stored in a memory resource 214. Processing resource 212 may fetch, decode, and execute instructions 216, 218, 220, 222. As an alternative or in addition to retrieving and executing instructions 216, 218, 220, 222, processing resource 212 may include a plurality of electronic circuits that include electronic components for performing the functionality of instructions 216, 218, 220, 222.

Memory resource 214 may be any electronic, magnetic, optical, or other physical storage device that stores executable instructions 216, 218, 220, 222 and/or data. Thus, memory resource 214 may be, for example, Random Access Memory (RAM), an Electrically-Erasable Programmable Read-Only Memory (EEPROM), a storage drive, an optical disc, and the like. Memory resource 214 may be disposed within computing device 202, as shown in FIG. 2. Additionally, memory resource 214 may be a portable, external or remote storage medium, for example, that causes computing device 202 to download the instructions 216, 218, 220, 222 from the portable/external/remote storage medium.

The computing device 202 may include instructions 216 stored in the memory resource 214 and executable by the processing resource 212 to determine an operating mode of the computing device 202. Operating modes of the computing device 202 can include a charging mode, a system battery mode, and/or a battery reserve mode.

The computing device 202 may include instructions 218 stored in the memory resource 214 and executable by the processing resource 212 to cause the battery 206 to charge in response to the operating mode being a charging mode. For example, although not illustrated in FIG. 2, the computing device 202 may be connected to a power source. In response to the computing device 202 determining the computing device 202 is connected to the power source, the computing device 202 can determine it is in the charging mode and in response, cause the battery 206 to charge.

The computing device 202 may include instructions 220 stored in the memory resource 214 and executable by the processing resource 212 to cause the battery 206 to power the computing device 202 in response to the operating mode being a system battery mode. For example, in response to the computing device 202 determining the computing device 202 is not connected to a power source and the battery 206 has a charge capacity that is greater than a threshold charge capacity, the computing device 202 can determine it is in the system battery mode and in response, cause the battery 206 to power the computing device 202.

The computing device 202 may include instructions 222 stored in the memory resource 214 and executable by the processing resource 212 to cause the battery 206 to power the component device 204 in absence of powering other components of the computing device 202 in response to the operating mode being a battery reserve mode. For example, in response to the computing device 202 determining that the computing device 202 is not connected to a power source and the battery 206 has a charge capacity that is less than a threshold charge capacity, the computing device 202 can determine it is in the battery reserve mode and in response, cause the battery 206 to power the component device 204 in absence of powering other components of the computing device 202.

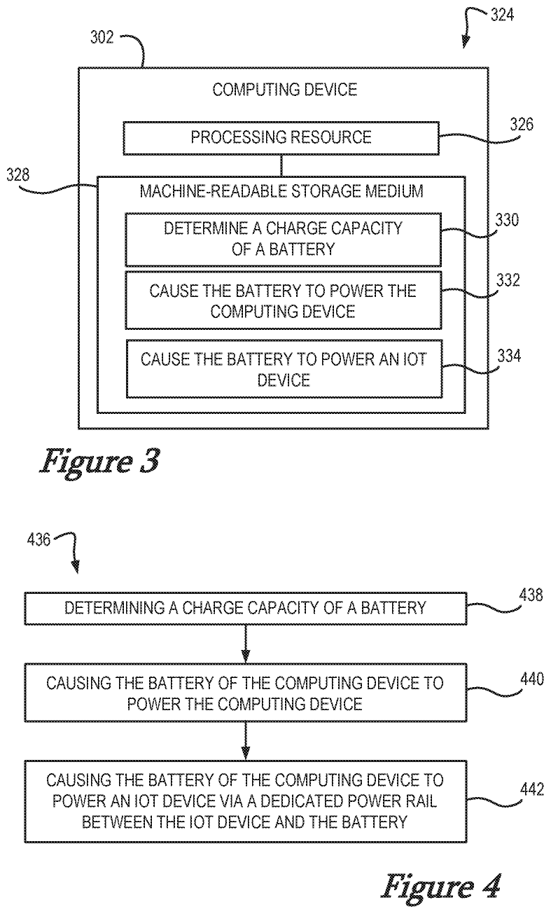

FIG. 3 illustrates a block diagram of an example system 324 consistent with the disclosure. In the example of FIG. 3, system 324 includes a computing device 302 having a processing resource 326 and a non-transitory machine-readable storage medium 328. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 326 may be a central processing unit (CPU), microprocessor, and/or other hardware device suitable for retrieval and execution of instructions stored in machine-readable storage medium 328. In the particular example shown in FIG. 3, processing resource 326 may receive, determine, and send instructions 330, 332, and 334. As an alternative or in addition to retrieving and executing instructions, processing resource 326 may include an electronic circuit comprising a number of electronic components for performing the operations of the instructions in machine-readable storage medium 328. With respect to the executable instruction representations or boxes described and shown herein, it should be understood that part or all of the executable instructions and/or electronic circuits included within one box may be included in a different box shown in the figures or in a different box not shown.

Machine-readable storage medium 328 may be any electronic, magnetic, optical, or other physical storage device that stores executable instructions. Thus, machine-readable storage medium 328 may be, for example, Random Access Memory (RAM), an Electrically-Erasable Programmable Read-Only Memory (EEPROM), a storage drive, an optical disc, and the like. The executable instructions may be “installed” on the system 324 illustrated in FIG. 3. Machine-readable storage medium 328 may be a portable, external or remote storage medium, for example, that allows the system 324 to download the instructions from the portable/external/remote storage medium. In this situation, the executable instructions may be part of an “installation package”. As described herein, machine-readable storage medium 328 may be encoded with executable instructions associated with computing devices with battery reserve modes.

Determine instructions 330, when executed by a processor such as processing resource 326, may cause system 324 to determine a charge capacity of a battery of the computing device 302. The system 324 can determine the charge capacity of the battery in response to the computing device 302 not being connected to a power source.

Cause instructions 332, when executed by a processor such as processing resource 326, may cause system 324 to cause the battery of the computing device to power the computing device. The system 324 can cause the battery of the computing device 302 to power the computing device 302 in response to the battery of the computing device 302 having a charge capacity that is greater than a threshold charge capacity. For example, in response to the computing device 302 not being connected to a power source and the battery having a charge capacity that is greater than a threshold charge capacity, the computing device 302 can determine it is in the system battery mode and in response, cause the battery to power the computing device 302.

Cause instructions 334, when executed by a processor such as processing resource 326, may cause system 324 to cause the battery of the computing device 302 to power an IoT device included as a component of the computing device in absence of powering other components of the computing device 302. The system 324 can cause the battery of the computing device to power the IoT device in absence of powering other components of the computing device 302 in response to the battery of the computing device 302 having a charge capacity that is less than a threshold charge capacity. For example, in response to the computing device 302 not being connected to a power source and the battery having a charge capacity that is less than the threshold charge capacity, the computing device 302 can determine it is in the battery reserve mode and in response, cause the battery power the IoT device in absence of powering other components of the computing device 302.

FIG. 4 illustrates an example of a method 436 for computing devices with battery reserve modes consistent with the disclosure. For example, method 436 can be performed by a computing device (e.g., computing device 102, 202, 302, previously described in connection with FIGS. 1-3, respectively).

At 438, the method 436 includes determining, by a computing device, a charge capacity of a battery. The computing device can determine the charge capacity of the battery in response to the computing device not being connected to a power source.

At 440, the method 436 includes causing, by the computing device, the battery of the computing device to power the computing device. The computing device can cause the battery to power the computing device in response to the computing device not being connected to a power source and the battery of the computing device having a charge capacity that is greater than a threshold charge capacity.

At 442, the method 436 includes causing, by the computing device, the battery of the computing device to power an IoT device via a dedicated power rail between the IoT device and the battery. The computing device can cause the battery to power the IoT device via the dedicated power rail in absence of powering other components of the computing device in response to the battery of the computing device having a charge capacity that is less than the threshold charge capacity of the battery.

The method 436 can be performed periodically at predetermined time intervals. For example, the computing device can determine a charge capacity of the battery every 60 seconds. Based on the determination of the charge capacity of the battery and/or whether or not the computing device is connected to a power source, the computing device can cause the battery to charge (e.g., in response to the computing device being connected to a power source), cause the battery to power the computing device (e.g., in a system battery mode in response to the computing device not being connected to a power source and a charge capacity of the battery being greater than a threshold charge capacity), or cause the battery to power the IoT device in absence of powering other components of the computing device (e.g., in a battery reserve mode in response to the computing device not being connected to a power source and a charge capacity of the battery being less than the threshold charge capacity).

Although the predetermined time interval is described above as being 60 seconds, examples of the disclosure are not so limited. For example, the predetermined time interval can be greater than 60 seconds or less than 60 seconds. Additionally, the predetermined time interval may be dependent on the battery charge capacity of the battery. For example, the predetermined time interval may be shorter in response to the battery charge capacity being closer to the charge capacity threshold (e.g., the charge capacity of the battery is less than a time interval threshold capacity (e.g., 30%) but greater than the charge capacity threshold (e.g., 2%)), or longer in response to the battery charge capacity being farther from the charge capacity threshold (e.g., the charge capacity of the battery is greater than a time interval threshold capacity (e.g., 30%)).

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure, Since many examples can be made without departing from the spirit and scope of the system and method of the disclosure, this specification merely sets forth some of the many possible example configurations and implementations.

What is claimed is:

1. A computing device, comprising:
a component device;
a battery; and
a memory resource storing non-transitory machine-readable instructions to cause a processing resource to:
determine an operating mode of the computing device;
in response to the operating mode being a charging mode, cause the battery to charge;
in response to the operating mode being a system battery mode, cause the battery to power the computing device; and
in response to the operating mode being a battery reserve mode, cause the battery to power the component device in absence of powering other components of the computing device.

2. The computing device of claim 1, wherein the processing resource is to determine the computing device is in the battery reserve mode in response to:
the battery having a charge capacity that is less than a threshold charge capacity; and
the computing device not being connected to a power source.

3. The computing device of claim 1, wherein the processing resource is to determine the computing device is in the system battery mode in response to:
the battery having a charge capacity that is greater than a threshold charge capacity; and
the computing device not being connected to a power source.

4. The computing device of claim 1, wherein the processing resource is to determine the computing device is in the charging mode in response to the computing device being connected to a power source.

5. The computing device of claim 1, wherein the processing resource is to cause the battery to power the component device via a dedicated power rail connected to the component device and the battery.

6. The computing device of claim 1, wherein the processing resource is to cause the battery to power the component device via a shared power rail connected to the component device, the other components, and the battery.

7. A non-transitory machine-readable medium including instructions that when executed cause a processing resource to:
determine, in response to a computing device not being connected to a power source, a charge capacity of a battery of the computing device;
cause, in response to the battery of the computing device having a charge capacity that is greater than a threshold charge capacity, the battery of the computing device to power the computing device; and
cause, in response to the battery of the computing device having a charge capacity that is less than the threshold charge capacity, the battery of the computing device to power an Internet-of-Things (IoT) device included as a component of the computing device in absence of powering other components of the computing device.

8. The medium of claim 7, wherein the processing resource is to prevent other components of the computing device from being powered by the battery in response to the battery having the charge capacity that is less than the threshold charge capacity.

9. The medium of claim 7, wherein the processing resource is to modify, in response to an input, the threshold charge capacity.

10. The medium of claim 7, wherein the processing resource is to:
detect an additional IoT device in response to the additional IoT device being connected to the computing device; and
cause, in response to the battery having the charge capacity that is less than the threshold charge capacity, the battery of the computing device to power the additional IoT device.

11. The medium of claim 7, wherein the processing resource is to cause, in response to the battery having the charge capacity that is less than the threshold charge capacity and in response to a request being received from the IoT device, a component of the computing device to be powered by the battery.

12. A method, comprising:
determining, by a computing device in response to the computing device not being connected to a power source, a charge capacity of a battery of the computing device;
causing, by the computing device in response to the battery of the computing device having a charge capacity that is greater than a threshold charge capacity, the battery of the computing device to power the computing device; and
causing, by the computing device in response to the battery of the computing device having a charge capacity that is less than the threshold charge capacity, the battery of the computing device to power an Internet-of-Things (IoT) device included as a component of the computing device via a dedicated power rail between the IoT device and the battery in absence of powering other components of the computing device.

13. The method of claim 12, wherein the method includes powering off the other components of the computing device in response to the battery charge capacity being less than the threshold charge capacity.

14. The method of claim 12, wherein the method includes powering the other components of the computing device in response to the computing device being connected to a power source.

15. The method of claim 12, wherein the method is performed periodically at predetermined time intervals.
